(19) United States
(12) Patent Application Publication
(10) Pub. No.: US 2011/0195869 A1
(43) Pub. Date: Aug. 11, 2011

(54) APPARATUS FOR SYNTHESIZING MICROARRAY PROBE, AND METHOD OF SYNTHESIZING MICROARRAY PROBE USING THE APPARATUS

(75) Inventors: Myoung-soon KIM, Seoul (KR); Sung-ouk JUNG, Hwaseong-si (KR); Sung-min CHI, Hwaseong-si (KR); Sang-yup AHN, Yongin-si (KR)

(73) Assignee: SAMSUNG ELECTRONICS CO., LTD., Suwon-si (KR)

(21) Appl. No.: 12/831,642

(22) Filed: Jul. 7, 2010

(30) Foreign Application Priority Data
Feb. 8, 2010 (KR) 10-2010-0011474

(51) Int. Cl. C40B 50/12; C40B 60/14

(52) U.S. Cl. 506/29; 506/40

(57) ABSTRACT

An apparatus for synthesizing a microarray probe, the apparatus including a capillary nozzle, and a method of synthesizing a microarray probe by using the apparatus. The probe is efficiently synthesized by using the apparatus.

### CROSS-REFERENCE TO RELATED APPLICATIONS

This application claims priority to Korean Patent Application No. 10-2010-0011474, filed on Feb. 8, 2010, and all the benefits accruing therefrom under 35 U.S.C. §119, the content of which in its entirety is herein incorporated by reference.

### BACKGROUND

1. Field

The general inventive concept relates to apparatuses for synthesizing a microarray probe, and methods of synthesizing a microarray probe using the apparatuses.

2. Description of the Related Art

A microarray including a probe that is fixed on a substrate and interacts specifically with a target material is used in various fields, such as environmental fields and medical fields, e.g., gene function analysis or disease-related gene diagnosis, since the microarray conveniently and accurately detects a signal generated when the target material and the probe are combined with each other.

Accordingly, various methods have recently been used to mass-produce microarrays. For example, a photolithography-based technology similar to that employed in semiconductor fields has been used. However, in order to obtain high productivity and reliability of the microarray, it is beneficial that the probe be quickly and accurately synthesized. Thus, an apparatus for and method of synthesizing a microarray probe has been actively studied.

### SUMMARY

Provided are apparatuses for synthesizing a microarray probe with substantially improved performance.

Also provided are methods of efficiently synthesizing a microarray probe using the apparatuses.

Additional aspects will be set forth in part in the description which follows and, in part, will be apparent from the description.

In an embodiment, an apparatus for synthesizing a microarray probe includes a fixer which fixes a substrate in a predetermined position in space and a liquid sprayer. The liquid sprayer includes a capillary nozzle including a spray unit end and which sprays a liquid received from a liquid container in a downward direction with respect to the capillary nozzle, and a supporter having a surface which exposes the spray unit end of the capillary nozzle, where the surface of the supporter is disposed apart from the fixer and moves in at least one of an upward direction and a downward direction with respect to the fixer.

In an embodiment, the liquid container may contain a solution comprising a biochemical material used to synthesize the microarray probe.

In an embodiment, the biochemical material may be at least one of a nucleotide molecule and a peptide molecule.

In an embodiment, the capillary nozzle may maintain a surface shape of the liquid transferred to the capillary nozzle to be substantially uniformly at the spray unit end of the capillary nozzle using capillary phenomena.

In an embodiment, the capillary nozzle may include a material selected from the group consisting of glass, quartz, Teflon, a chemical resistive polymer and a combination thereof.

In an embodiment, the spray unit end of the capillary nozzle may be coated by a material selected from the group consisting of glass, quartz, Teflon, a chemical resistive polymer and a combination thereof.

In an embodiment, the liquid sprayer may move upward or downward such that a surface shape of the liquid transferred to the capillary nozzle contacts the substrate fixed to the fixer, and the surface shape of the liquid transferred to the capillary nozzle may be maintained to be substantially uniform at the spray unit end of the capillary nozzle by capillary phenomena while the liquid sprayer moves.

In an embodiment, the liquid sprayer may be moved upward or downward such that a distance between the surface of the supporter and the substrate fixed to the fixer is in the range from about 10 micrometers to about 5,000 micrometers.

In an embodiment, the liquid sprayer may be moved upward or downward such that a distance between the surface of the supporter and the substrate fixed to the fixer is about 150 micrometers.

In an embodiment, the spray unit end of the capillary nozzle may include a valve disposed therein and which controls a flow of the liquid.

In an embodiment, the liquid sprayer may include a liquid storage chamber in fluid communication with a liquid inlet of the capillary nozzle.

In an embodiment, the liquid storage chamber may be connected to a liquid mixer which mixes a liquid contained in the liquid storage chamber.

In an embodiment, the fixer may be connected to a vibrator disposed to vibrate the fixer.

In an embodiment, the surface of the supporter which exposes the spray unit end of the capillary nozzle may be disposed substantially parallel and symmetrically to a surface of the fixer.

In an embodiment, a method of synthesizing a microarray probe includes providing an apparatus for synthesizing a microarray probe, contacting a surface of the liquid transferred to the capillary nozzle with the substrate fixed to the fixer by moving a liquid sprayer upward or downward, wherein a shape of the surface shape of the liquid is substantially uniformly maintained at the spray unit end of the capillary nozzle, and locating the liquid contacting the substrate on a predetermined probe region of the substrate by capillary phenomena. The apparatus for synthesizing a microarray probe includes a fixer which fixes a substrate in a predetermined position in space, and a liquid sprayer which includes a capillary nozzle including a spray unit end and which sprays a liquid received from a liquid container in a downward direction with respect to the capillary nozzle and a supporter having a surface which exposes the spray unit end of the capillary nozzle, where the surface of the supporter is disposed apart from the fixer and moves in at least one of an upward direction and a downward direction with respect to the fixer.

In an embodiment, the apparatus for synthesizing a microarray probe may further include a vibrator disposed to vibrate the fixer, and the method of synthesizing a microarray probe may further include vibrating the fixer with the vibrator of the apparatus med.

In an embodiment, the method of synthesizing a microarray probe may further include cleaning the substrate by transferring a cleaning solution through the capillary nozzle.

In an embodiment, an apparatus for synthesizing a microarray probe includes a probe synthesizer including a fixer which fixes a substrate in a predetermined position in space and a liquid sprayer including a capillary nozzle which sprays a liquid in a downward direction with respect to the capillary nozzle, and a supporter having a surface which exposes a spray unit end of the capillary nozzle, where the surface of the supporter is disposed apart from the fixer and moves upward or downward with respect to the fixer, a loader which provides a substrate to the fixer and a solution supplier which supplies a solution to the capillary nozzle.

The apparatus of claim 19, further comprising a humidity maintainer which maintains a humidity of the probe synthesizer.

### BRIEF DESCRIPTION OF THE DRAWINGS

These and/or other aspects will become apparent and more readily appreciated from the following description of the embodiments, taken in conjunction with the accompanying drawings in which:

FIG. 1 a schematic diagram of an embodiment of an apparatus for synthesizing a microarray probe according to the present inventive concept;

FIG. 2 is a partial schematic diagram of an embodiment of an apparatus for synthesizing the microarray probe showing a shape of a surface of a liquid, which is uniformly maintained at a spray unit end of a capillary nozzle of the apparatus;

FIGS. 3A through 3E are partial schematic diagrams of an embodiment of an apparatus for synthesizing a microarray probe showing a shape of a surface of a liquid that is uniformly maintained at a spray unit end of a capillary nozzle of the apparatus while the liquid is transferred to a probe region of a substrate;

FIG. 4 is a partial schematic diagram of an embodiment of an apparatus for synthesizing a microarray probe showing a capillary nozzle of the apparatus according to the present inventive concept;

FIG. 5 is a partial schematic diagram of an alternative embodiment of an apparatus for synthesizing a microarray probe including a valve disposed at a spray unit end of a capillary nozzle of the apparatus according to the present inventive concept;

FIG. 6 is a schematic diagram of an embodiment of an apparatus for synthesizing a microarray probe including a liquid storage chamber and a liquid mixer, which are fluid-communicatively connected to a capillary nozzle of the apparatus; and

FIG. 7 is a schematic diagram of an embodiment of an apparatus for synthesizing a microarray probe including a vibrator which vibrates a fixer of the apparatus according to the present inventive concept.

### DETAILED DESCRIPTION

Reference will now be made in detail to embodiments, examples of which are illustrated in the accompanying drawings, wherein like reference numerals refer to the like elements throughout. In this regard, the present embodiments may have different forms and should not be construed as being limited to the descriptions set forth herein. Accordingly, the embodiments are merely described below, by referring to the figures, to explain aspects of the present description. Like reference numerals refer to like elements throughout.

It will be understood that when an element is referred to as being “on” another element, it can be directly on the other element or intervening elements may be present therebetween. In contrast, when an element is referred to as being “directly on” another element, there are no intervening elements present. As used herein, the term “and/or” includes any and all combinations of one or more of the associated listed items.

It will be understood that, although the terms first, second, third etc. may be used herein to describe various elements, components, regions, layers and/or sections, these elements, components, regions, layers, and/or sections should not be limited by these terms. These terms are only used to distinguish one element, component, region, layer, or section from another element, component, region, layer or section. Thus, a first element, component, region, layer or section discussed below could be termed a second element, component, region, layer or section without departing from the teachings of the present invention.

The terminology used herein is for the purpose of describing particular embodiments only and is not intended to be limiting. As used herein, the singular forms “a,” “an,” and “the” are intended to include the plural forms as well, unless the context clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom” and “upper” or “top,” may be used herein to describe one element's relationship to another elements as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower,” can therefore, encompasses both an orientation of “lower” and “upper,” depending on the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Exemplary embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

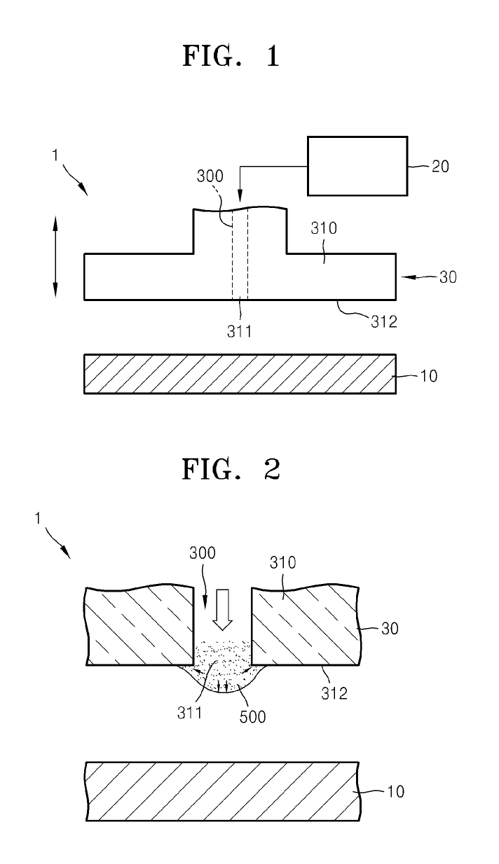

FIG. 1 a schematic diagram of an embodiment of an apparatus 1 for synthesizing a microarray probe according to the present inventive concept.

A microarray is a device including a probe that is fixed to a substrate to combine with a target material. The target material includes all biomaterials to be detected. Examples of the biomaterials include nucleic acid, peptide, protein, sugar, virus, cell, and organelle, but not being limited thereto. The biomaterial includes a material that is derived from an organism or that is synthesized or semi-synthesized with the organism. The probe may include at least one biomaterial monomer. Examples of the biomaterial may include deoxyribonucleic acid (“DNA”), ribonucleic acid (“RNA”), nucleotide, nucleoside, protein, polypeptide, peptide, amino acid, carbohydrate, enzyme, antibody, antigen, receptor, virus, stroma, ligand, membrane and a combination thereof, but not being limited thereto. The microarray may be used for various reactions, such as bio or biochemical reactions, for example. In an embodiment, when the existence of a target nucleic acid is to be detected, a microarray, where a nucleic acid probe having a complementary sequence to the well known target nucleic acid is fixed to a substrate, is provided, a sample including the target nucleic acid marked with a detectable label, e.g., a fluorescent material, is introduced in the microarray, and then the nucleic acid probe and the target nucleic acid are mixed. After the nucleic acid probe and the target nucleic acid are mixed, the mixture may be cleaned to remove a material that is not mixed, and an excitation light may be irradiated on the fluorescent material of the mixture to detect the fluorescent material emitting light in response to the excitation light using a microarray scan system.

The apparatus synthesizes the probe that is combinable with the target material on the substrate. A method of synthesizing a probe using the apparatus may include a method of directly synthesizing the probe on the substrate by stacking a biomaterial monomer on the substrate, and a method of disposing an already-synthesized probe on the substrate. In an embodiment, the probe may be in-situ synthesized on a silicon substrate using photolithography that is widely used in semiconductor fields. A functional group that is synthesizable with each biomaterial monomer is pre-introduced on a substrate, and an end of the functional group is protected by a photolabile chemical material. When light is irradiated on a certain region of the substrate using a photomask, the photolabile chemical material is removed and only the functional group that is synthesizable with each biomaterial monomer is exposed. Here, the biomaterial monomer is stacked only on a region in which the functional group is activated as the light is irradiated thereon. Then, processes of removing an un-reacted biomaterial monomer and selectively combining a predetermined biomaterial monomer on the substrate using a photomask having a different pattern are repeated so as to synthesize a probe having a desired arrangement on a certain region of the substrate. Embodiments of the apparatus include all apparatuses that perform such a method.

As shown in FIG. 1, the apparatus 1 includes a fixer 10 that fixes a substrate (not shown) in a predetermined position in space; and a supporter 310 including a capillary nozzle 300, which sprays liquid received from a liquid container 20 downward, and a surface 312, which exposes a spray unit end 311 of the capillary nozzle 300. In an embodiment, the surface 312 includes a liquid sprayer 30 that moves upward or downward, and is disposed apart from the fixer 10.

The apparatus 1 synthesizes a probe that is complementarily combinable with a target material on the substrate.

The apparatus 1 includes the fixer 10 that fixes the substrate. The substrate may be formed of a material to which the probe that is combinable with the target material is combinable, for example, quartz, silicon, glass, a metal, plastic, or ceramic. When the substrate is formed of silicon, the substrate may be processed by using an oxide layer, such as a silicon dioxide (SiO₂) layer. A surface of the substrate may be processed by using a variety of materials so that the probe and the oxide layer are combined with each other. Variety of materials for processing the substrate may be used including a material, such as various types of linker, an amine group, a carboxyl group, an epoxy group, a sulfur group, an aldehyde group, activated ester and maleimide, for example. The substrate may have a flat, bead, or spherical shape, but not being limited thereto. In an embodiment, the substrate may include a predetermined region on which the probe is disposed. The predetermined region may be determined according to a use and type of the microarray. The fixer 10 fixes the substrate when the probe is synthesized on the substrate. A shape of the fixer 10 may differ according to a shape of the substrate. In an embodiment, the fixer 10 may have a flat, bead, or spherical shape, for example, but not being limited thereto. In FIG. 1, the fixer 10 has a flat shape. The fixer 10 may include a fixing unit (not shown) to fix the substrate in the predetermined position in space. In an embodiment, the fixer 10 may include a through hole contacting the substrate on a surface thereof, for example. A negative pressure, e.g., a vacuum pressure, may be applied through the through hole to fix the substrate. When the negative pressure is not applied through the through hole, the substrate may be separated from the fixer 10.

The apparatus 1 includes the supporter 310 including the capillary nozzle 300, which sprays the liquid received from the liquid container 20 downward, and the surface 312, which exposes the spray unit end 311 of the capillary nozzle 300. The surface 312 includes the liquid sprayer 30 that moves upward or downward and is disposed apart from the fixer 10.

The capillary nozzle 300 is configured to spray the liquid received from the liquid container 20 downward. The liquid container 20 contains a solution including a biochemical material required to synthesize the probe, for example, a solution including a biomaterial or a biomaterial monomer, a buffer solution, or a cleaning solution, but a solution contained in the liquid container 20 is not limited thereto. The biochemical material may be a nucleotide or peptide molecule, for example. Accordingly, the probe may be a nucleic acid probe or a peptide probe. The liquid container 20 may be in fluid communication with an end portion of the capillary nozzle 300 except for the spray unit end 311, or integrated with the capillary nozzle 300 in one body. In an alternative embodiment, the liquid container 20 may be connected to a pump, which provides a positive or negative pressure to move the liquid to the spray unit end 311 of the capillary nozzle 300, or disposed in such a way that the pump is operable. The liquid received from the liquid container 20 is sprayed downward through the capillary nozzle 300.

The supporter 310 has the surface 312, which exposes the spray unit end 311 of the capillary nozzle 300 so that the liquid received from the liquid container 20 is sprayed downward through the capillary nozzle 300. The surface 312 may be disposed substantially opposite to, e.g., facing, the fixer 10. Referring to FIG. 1, the surface 312 is disposed substantially parallel and symmetrical to a surface of the fixer 10. Accordingly, the liquid sprayed on the substrate when fixed to the fixer 10 is effectively prevented from leaving the substrate, and the surface 312 may smoothly move upward or downward.

The liquid sprayer 30 may be disposed to be movable upward or downward while being spaced apart from the fixer 10. The liquid sprayer 30 may move upward or downward so that a distance between the surface 312 and the substrate fixed to the fixer 10 is in the range from about 10 micrometers (μm) to about 5,000 micrometers (μm). In an embodiment, the liquid sprayer 30 may move upward or downward so that the distance is about 150 μm. In an embodiment, a thickness of the substrate may be predetermined, and the liquid sprayer 30 may move upward or downward to adjust the distance between it and the substrate based on the thickness of the substrate. Accordingly, the distance is adjusted by moving the liquid sprayer 30 upward or downward such that a shape of a surface of the liquid, which is substantially uniformly maintained at the spray unit end 311 by capillary phenomena, contacts the substrate fixed to the fixer 10. Consequently, since a distance between the spray unit end 311 and the substrate is minimized, contact with the external environment is minimized, and thus contamination that may occur while synthesizing the probe may be effectively prevented and the amount of supplied liquid may be substantially minimized.

FIG. 2 is a partial schematic diagram of an embodiment of an apparatus for synthesizing the microarray probe 1 showing a shape of a surface of a liquid 500, which is substantially uniformly maintained at the spray unit end 311 of the capillary nozzle 300 of the apparatus 1.

As shown in FIG. 2, the capillary nozzle 300 is configured to substantially uniformly maintain a shape of a surface of the liquid 500 at the spray unit end 311 of the capillary nozzle 300 received from a liquid container. The capillary nozzle 300 is disposed in a downward direction to spray the liquid 500 downward. Accordingly, the liquid 500 is sprayed in a direction substantially parallel to a direction of gravity force applied to the liquid 500. In an embodiment, the liquid 500 sprayed through the capillary nozzle 300 may be sprayed on the substrate fixed to the fixer 10. The capillary nozzle 300 is configured to substantially uniformly maintain the shape of the surface of the liquid 500 at the spray unit end 311 using capillary phenomena. The capillary phenomenon is typically generated by an attractive force between liquid molecules in a narrow tube and a mutually attractive force between a surface of a liquid and a surface of the tube. The capillary nozzle 300 has a shape substantially similar to a narrow tube shape and includes the spray unit end 311 that sprays the liquid 500 downward. Accordingly, the shape of the surface of the liquid 500 is substantially uniformly maintained at the spray unit end 311 by capillary phenomena against gravity. Referring to FIG. 2, the liquid 500 received from the liquid container is attracted toward an inner wall of the capillary nozzle by capillary phenomena at the spray unit end 311 of the capillary nozzle 300. A resultant force of an attractive force from the inner wall of the capillary nozzle 300 and an attractive force between liquid molecules of the liquid 500 acts as an opposite force with respect to gravity action on the spray unit end 311 of the capillary nozzle 300, and thus the shape of the surface of the liquid 500 is uniformly maintained. Accordingly, the capillary nozzle 300 is configured such that the shape of the surface of the liquid 500 at the spray unit end 311 is uniformly maintained by capillary phenomena.

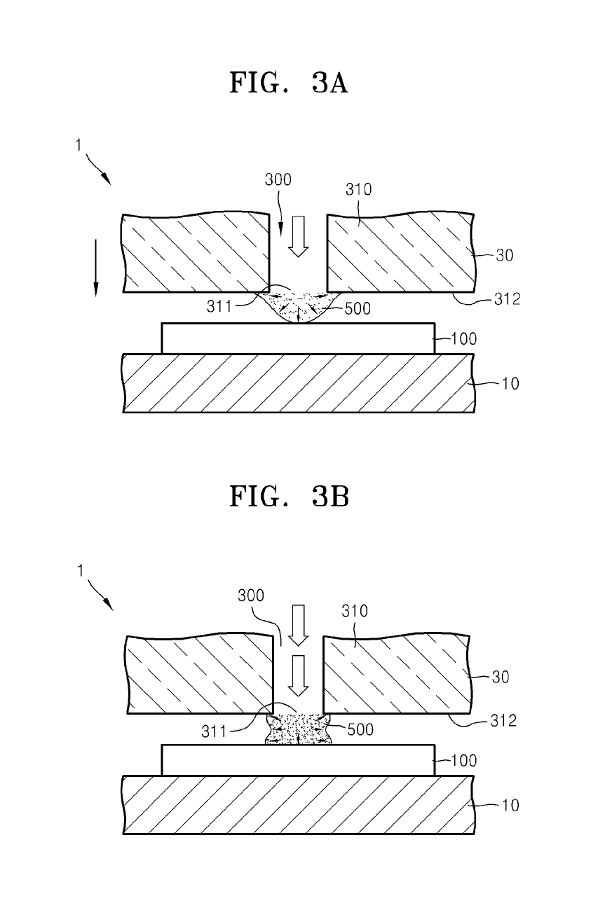

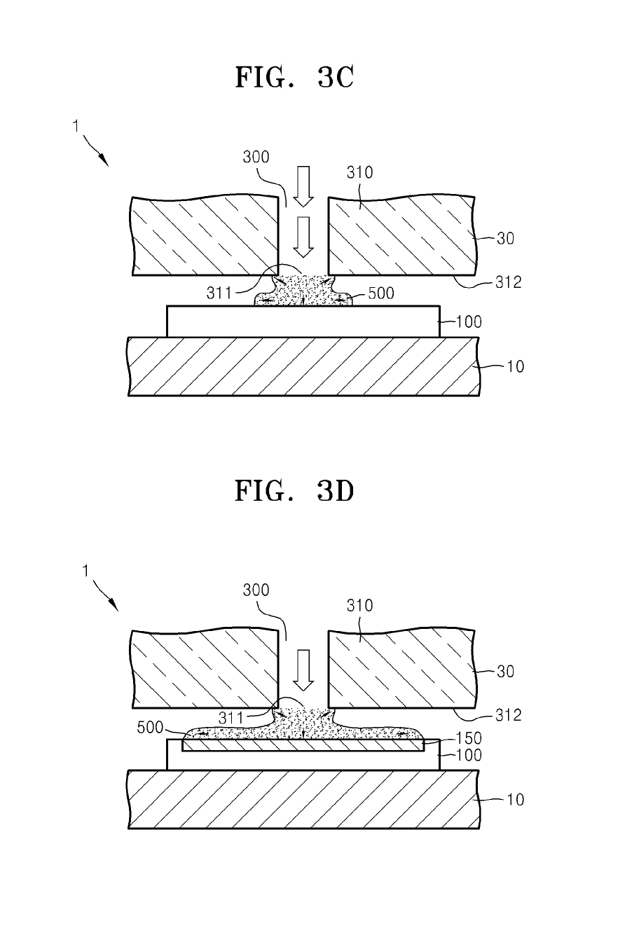

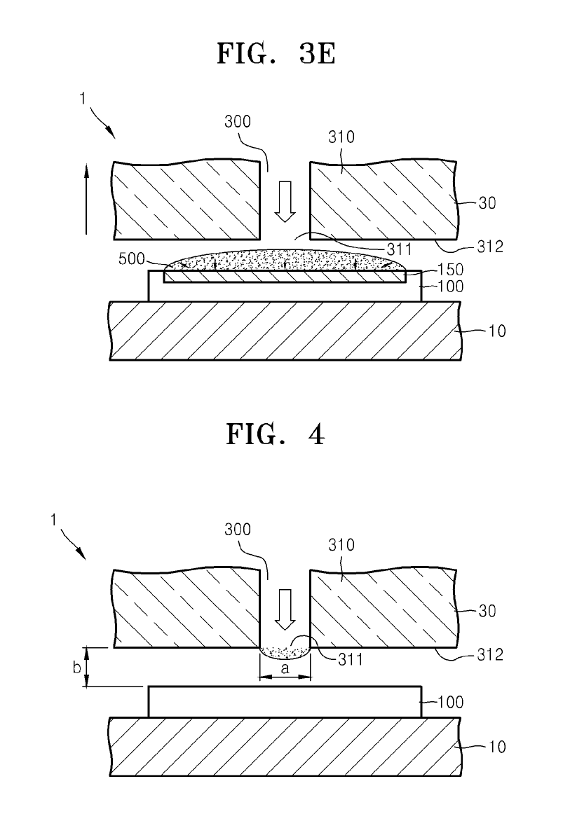

FIGS. 3A through 3E are partial schematic diagrams of an embodiment of an apparatus for synthesizing a microarray probe showing the surface shape of the liquid 500 that is uniformly maintained at the spray unit end 311 of the capillary nozzle 300 of the apparatus 1 while of the liquid 500 is transferred to a substrate 100.

FIG. 3A shows the shape of the surface of the liquid 500 substantially uniformly maintained at the spray unit end 311 of the capillary nozzle 300 contacting the substrate 100 that is fixed to the fixer 10. The shape of the surface of the liquid 500 is substantially uniformly maintained at the spray unit end 311 as described above. Then, the liquid sprayer 30 moves downward such that the shape of the surface of the liquid 500 contacts the substrate 100. In an embodiment, the liquid sprayer 30 may move upward or downward to be disposed at a predetermined location between the surface 312 and the substrate 100 fixed to the fixer 10, and then the shape of the surface of the liquid 500 may contact the substrate 100 while the shape of the surface of the liquid is substantially uniformly maintained at the spray unit end 311.

FIGS. 3B and 3C show the shape of the surface of the liquid 500 that is substantially uniformly maintained at the spray unit end 311 while being spread on the substrate 100 fixed to the fixer 10.

The liquid 500 contacting the substrate 100 may spread on the substrate 100 by gravity and pressure of the liquid 500 applied from an end of the capillary nozzle 300 except for the spray unit end 311. In an embodiment, an amount of the liquid 500 passing through the spray unit end 311 may be adjusted by controlling the pump which provides a positive or negative pressure to a liquid container.

FIG. 3D shows the shape of the surface of the liquid 500 being spread on the substrate 100 and disposed in a predetermined probe region 150 of the substrate 100.

The liquid 500 contacting the substrate 100 may spread on the substrate 100 by gravity and pressure of the liquid 500 applied from the other end of the capillary nozzle 300, and may be disposed on the probe region 150 of the substrate 100. The amount of the liquid 500 passing through the spray unit end 311 may be adjusted by controlling the pump which provides a positive or negative pressure to the liquid container.

FIG. 3E shows the liquid 500 sprayed from the spray unit end 311 disposed on the probe region 150 of the substrate 100 fixed to the fixer 10.

After the liquid 500 is disposed on the probe region 150, the liquid sprayer 30 is moved upward so that the surface shape of the liquid 500 is separated from the substrate 100. Then, a biomaterial monomer included in the liquid 500 contacts the substrate 100 and is combined on the substrate 100.

FIG. 4 is a partial schematic diagram of an embodiment of an apparatus for synthesizing a microarray probe showing the capillary nozzle 300 of the apparatus 1 according to the present inventive concept.

The capillary nozzle 300 is configured to uniformly maintain a shape of a surface of liquid transferred to the capillary nozzle 300 at the spray unit end 311 of the capillary nozzle 300. A material and shape of the capillary nozzle 300 may be predetermined. In an embodiment, the capillary nozzle 300 may include a material such as glass, quartz, Teflon and chemical resistive polymer, or other materials with similar characteristics, for example. In an alternative embodiment, the spray unit end 311 of the capillary nozzle 300 may be coated with a material such as glass, quartz, Teflon, and chemical resistive polymer, or other materials with similar characteristics, for example. A diameter of the capillary nozzle 300 may be in a range from about 100 μm to about 5,000 μm. In an embodiment, when a material and a width a of the capillary nozzle 300 are predetermined, the shape of the surface of the liquid uniformly maintained at the spray unit end 311 may vary according to characteristics of the liquid, for example, a type, viscosity, or concentration of a solute or solvent. Thus, a distance b between the surface 312 of the supporter 310 and the substrate 100 may vary. Accordingly, the width a and the distance b may be variously determined according to the characteristics of the liquid such that the shape of the surface of the liquid 500 transferred to the capillary nozzle 300 is substantially uniformly maintained at the spray unit end 311 by capillary phenomena.

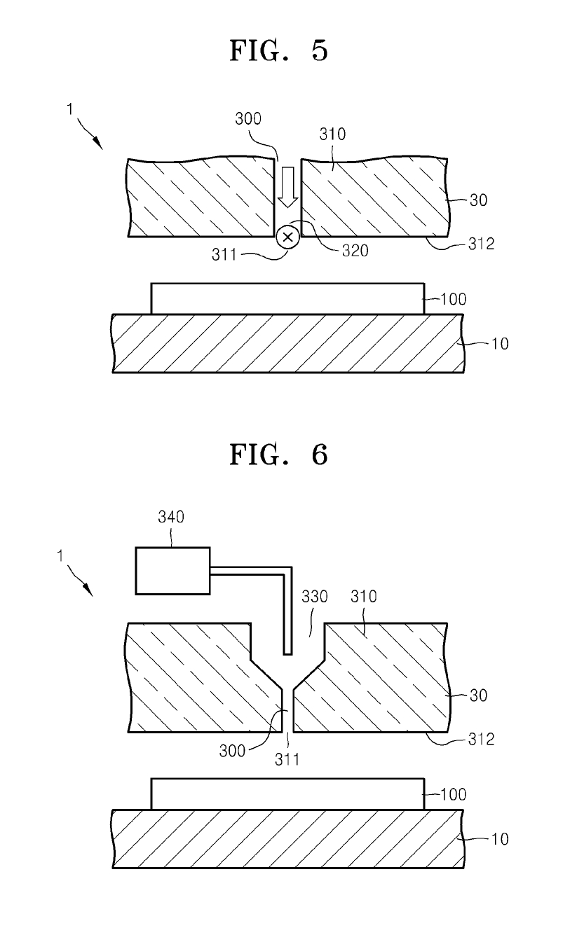

FIG. 5 is a partial schematic diagram of an alternative embodiment of an apparatus for synthesizing a microarray probe including a valve 320 disposed at the spray unit end 311 of the capillary nozzle 300 of the apparatus 1, according to an embodiment of the present inventive concept.

The spray unit end 311 of the capillary nozzle 300 may include the valve 320 which controls a flow of the liquid. Sprayability and an amount of the liquid sprayed from the spray unit end 311 are controlled by the valve 320.

FIG. 6 is a schematic diagram of an embodiment of an apparatus for synthesizing a microarray probe including a liquid storage chamber 330 and a liquid mixer 340, which are in fluid communication with the capillary nozzle 300 of the apparatus 1.

The liquid sprayer 30 may include the liquid storage chamber 330 that is in fluid communication with a liquid inlet of the capillary nozzle 300, and the liquid storage chamber 330 may store liquid received from a liquid container. In an embodiment, the liquid sprayer 30 may be connected to the liquid mixer 340, which mixes the liquid contained in the liquid storage chamber 300, or disposed in such a way that the liquid mixer 340 is operable. Accordingly, liquid to be sprayed on the substrate 100 from the liquid storage chamber 330, e.g., a solution including a biochemical material required to synthesize the probe, is mixed to increase a yield of synthesizing the probe.

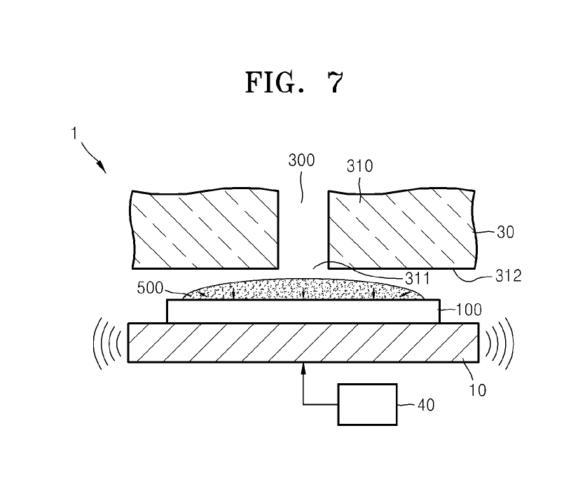

FIG. 7 is a schematic diagram of an embodiment of an apparatus for synthesizing a microarray probe including a vibrator 40 disposed to vibrate the fixer 100 of the apparatus 1 according to the present inventive concept.

The fixer 10 of the apparatus 1 may be connected to the vibrator 40, which is configured to vibrate the fixer 10, or may be disposed in such a way that the vibrator 40 is operable. The vibrator 40 may vibrate the fixer 10 to transfer the vibration to a surface of the substrate 100 fixed to the fixer 10. Accordingly, reactivity between the biomaterial monomer included in the liquid and the surface of the substrate 100, for example, the number of times that the biomaterial monomer contacts the surface of substrate 100, may be increased. In an embodiment, the vibrator 40 may vibrate the surface of the substrate 100 at about 0 hertz (Hz) to about 10 hertz (Hz).

### Experiment

In the experiment, a stacking yield of a probe prepared using an embodiment of an apparatus for synthesizing a microarray probe according to the present inventive concept was examined.

First, an embodiment of the apparatus for synthesizing a microarray probe was prepared. The apparatus included: a probe synthesizer including a fixer, which fixes a substrate, a liquid sprayer including a capillary nozzle, which sprays a liquid downward, and a supporter having a surface that exposes a spray unit end of the capillary nozzle, where the surface of the supporter is configured to be movable upward or downward and is disposed apart from the fixer; a loader, which provides a substrate to the fixer; and a solution supplier, which supplies a solution to the capillary nozzle.

A silicon substrate having a thickness of about 200 millimeters (mm) was prepared, and an aminopropyl-triethoxysilane (“APTS”) layer was formed on the silicon substrate using a sol-gel reaction. The silicon substrate on which the APTS layer was formed was stored in a vacuum oven.

The silicon substrate was put into the loader of the apparatus, moved from the loader to the fixer using a substrate transfer robot, and fixed to the fixer. The probe synthesizer was processed with an inert gas, such as helium (He), nitrogen gas (N₂), or argon (Ar) gas, for example, and maintained under predetermined humidity conditions. A liquid including nucleotide having each base forming a desired nucleic acid sequence (e.g., GCGGC ATTTA GTTAG CTACT CAACG) was transferred to the liquid container. A shape of a surface of the liquid was substantially uniformly maintained at the spray unit end of the capillary nozzle, and then the liquid sprayer was moved downward so that the shape of the surface of the liquid contacts the silicon substrate. The liquid contacting the silicon substrate is spread on the silicon substrate to dispose the liquid on a predetermined probe region of the silicon substrate. Then, a cleaning solution was transferred to the capillary nozzle to clean the probe region of the silicon substrate. In an element, the processes from contacting the shape of the surface of the liquid on the silicon substrate to cleaning the probe region were repeated to synthesize a probe of the desired nucleic acid sequence (e.g., GCGGC ATTTA GTTAG CTACT CAACG), and a first combining yield (T1) of the probe with a target material was repeatedly measured. In an alternative element, while the liquid is disposed on the silicon substrate, the fixer was vibrated with about 10 Hz to synthesize a probe of the same nucleic acid sequence as above, and a second combining yield (T2) of the probe with the target material was repeatedly measured.

In another alternative element, a microarray having a probe of the desired nucleic acid sequence as above was prepared as above except that liquid was directly sprayed without using a capillary phenomenon, and a third combining yield (a1) of the probe with a target material was repeatedly measured to be compared with the first combining yield (T1). In still another alternative element, a microarray having a probe of the same nucleic acid sequence as above was prepared as above except that the liquid was directly sprayed without using capillary phenomena and without vibrating a fixer, and a fourth combining yield (b1) of the probe with a target material was repeatedly measured to be compared with the second combining yield (T2). As a result, an average of the first combining yield (T1) was at least about 70% higher than an average of the third combining yield (a1), and an average of the second combining yield (T2) was at least about 80% higher than an average of the fourth combining yield (b1).

As described above, a probe in a microarray is substantially efficiently synthesized using one or more of embodiments of an apparatus for synthesizing a microarray probe which substantially improves performance in synthesizing the probe.

The present invention should not be construed as being limited to the embodiments set forth herein. Rather, these embodiments are provided so that this disclosure will be thorough and complete and will fully convey the concept of the present invention to those skilled in the art.

While the present invention has been particularly shown and described with reference to the embodiments thereof, it will be understood by those of ordinary skill in the art that various changes in form and details may be made therein without departing from the spirit or scope of the present invention as defined by the following claims.

What is claimed is:

1. An apparatus for synthesizing a microarray probe, the apparatus comprising:
a fixer which fixes a substrate in a predetermined position in space; and
a liquid sprayer comprising:
a capillary nozzle including a spray unit end and which sprays a liquid received from a liquid container in a downward direction with respect to the capillary nozzle; and
a supporter having a surface which exposes the spray unit end of the capillary nozzle,
wherein the surface of the supporter is disposed apart from the fixer and moves in at least one of an upward direction and a downward direction with respect to the fixer.

2. The apparatus of claim 1, wherein the liquid container contains a solution comprising a biochemical material used to synthesize the microarray probe.

3. The apparatus of claim 2, wherein the biochemical material is at least one of a nucleotide molecule and a peptide molecule.

4. The apparatus of claim 1, wherein the capillary nozzle maintains a surface shape of the liquid transferred to the capillary nozzle to be substantially uniformly at the spray unit end of the capillary nozzle using capillary phenomena.

5. The apparatus of claim 1, wherein the capillary nozzle includes a material selected from the group consisting of glass, quartz, Teflon, a chemical resistive polymer and a combination thereof.

6. The apparatus of claim 1, wherein the spray unit end of the capillary nozzle is coated by a material selected from the group consisting of glass, quartz, Teflon, a chemical resistive polymer and a combination thereof.

7. The apparatus of claim 1, wherein a diameter of the capillary nozzle is in the range from about 100 micrometers to about 5,000 micrometers.

8. The apparatus of claim 1, wherein
the liquid sprayer moves upward or downward such that a surface shape of the liquid transferred to the capillary nozzle contacts the substrate fixed to the fixer, and
the surface shape of the liquid transferred to the capillary nozzle is maintained to be substantially uniform at the spray unit end of the capillary nozzle by capillary phenomena while the liquid sprayer moves.

9. The apparatus of claim 1, wherein the liquid sprayer is moved upward or downward such that a distance between the surface of the supporter and the substrate fixed to the fixer is in the range from about 10 micrometers to about 5,000 micrometers.

10. The apparatus of claim 1, wherein the liquid sprayer is moved upward or downward such that a distance between the surface of the supporter and the substrate fixed to the fixer is about 150 micrometers.

11. The apparatus of claim 1, wherein the spray unit end of the capillary nozzle comprises a valve disposed therein and which controls a flow of the liquid.

12. The apparatus of claim 1, wherein the liquid sprayer comprises a liquid storage chamber in fluid communication with a liquid inlet of the capillary nozzle.

13. The apparatus of claim 12, wherein the liquid storage chamber is connected to a liquid mixer which mixes a liquid contained in the liquid storage chamber.

14. The apparatus of claim 1, wherein the fixer is connected to a vibrator disposed to vibrate the fixer.

15. The apparatus of claim 1, wherein the surface of the supporter which exposes the spray unit end of the capillary nozzle is disposed substantially parallel and symmetrically to a surface of the fixer.

16. A method of synthesizing a microarray probe, the method comprising:
providing an apparatus for synthesizing a microarray probe, the apparatus comprising:
a fixer which fixes a substrate in a predetermined position in space; and
a liquid sprayer comprising:
a capillary nozzle including a spray unit end and which sprays a liquid received from a liquid container in a downward direction with respect to the capillary nozzle; and
a supporter having a surface which exposes the spray unit end of the capillary nozzle,
wherein the surface of the supporter is disposed apart from the fixer and moves in at least one of an upward direction and a downward direction with respect to the fixer;
fixing a substrate on the fixer;
transferring a liquid to the capillary nozzle;
contacting a surface of the liquid transferred to the capillary nozzle with the substrate fixed to the fixer by moving a liquid sprayer upward or downward, wherein a shape of the surface shape of the liquid is substantially uniformly maintained at the spray unit end of the capillary nozzle; and
locating the liquid contacting the substrate on a predetermined probe region of the substrate by capillary phenomena.

17. The method of claim 16, wherein the apparatus further comprises a vibrator disposed to vibrate the fixer, and the method further comprises vibrating the fixer with the vibrator of the apparatus.

18. The method of claim 16, further comprising cleaning the substrate by transferring a cleaning solution through the capillary nozzle.

19. An apparatus for synthesizing a microarray probe, the apparatus comprising:
a probe synthesizer comprising:
a fixer which fixes a substrate in a predetermined position in space; and
a liquid sprayer comprising:
a capillary nozzle which sprays a liquid in a downward direction with respect to the capillary nozzle; and
a supporter having a surface which exposes a spray unit end of the capillary nozzle, wherein the surface of the supporter is disposed apart from the fixer and moves upward or downward with respect to the fixer;
a loader which provides a substrate to the fixer; and
a solution supplier which supplies a solution to the capillary nozzle.

20. The apparatus of claim 19, further comprising a humidity maintainer which maintains a humidity of the probe synthesizer.


SEQUENCE LISTING (1 sequence)

SEQ ID NO: 1 - DNA, 25 bp, Artificial Sequence
  probe of the desired nucleic acid sequence
gcggcatttagttagctactcaacg